(19) United States
(12) Patent Application Publication
(10) Pub. No.: US 2015/0069903 A1
(43) Pub. Date: Mar. 12, 2015

(54) ELECTRIC LAMP AND ASSEMBLING METHOD THEREFORE

(71) Applicant: KONINKLIJKE PHILIPS N.V., EINDHOVEN (NL)

(72) Inventor: Wilfried Appeltants, Eindhoven (NL)

(21) Appl. No.: 14/399,118

(22) PCT Filed: Apr. 26, 2013
(86) PCT No.: PCT/IB2013/053326

§ 371 Date: Nov. 5, 2014

Related U.S. Application Data
(60) Provisional application No. 61/643,562, filed on May 7, 2012.

(51) Int. Cl. H01J 5/60; H01J 9/34; H01J 61/30

(52) U.S. Cl. CPC H01J 5/60; H01J 61/30; H01J 9/34
USPC 313/318.01; 445/23

(57) ABSTRACT

An electric lamp (1) comprising a gastight lamp vessel (3) mounted on a base (19). The lamp vessel is surrounded by a sleeve (25) having an open end (28), the base is connected at the open end of the sleeve. An essentially tubular shaped connection part connects the base to the sleeve without the use of cement. There to the sleeve extends through a first opening (32) of the connection part and engages with a radially, outwardly bulging portion (29) a radially, inwardly extending portion (31) of the connection part. The base extends through a second opening (33) of the connection part opposite to the first opening and is fixed to the connection part without cement.

### FIELD OF THE INVENTION

The invention relates to an electric lamp comprising a gastight lamp vessel mounted on a base, the lamp vessel being surrounded by a sleeve having a length axis and an open end, the base being connected at the open end of the sleeve.

### BACKGROUND OF THE INVENTION

An exemplary embodiment of such a lamp is known from U.S. Pat. No. 7,345,412. The known lamp has a sleeve fixed to the base via cement. Such a sleeve is present to protect users from accidently touching the possibly hot lamp vessel or to provide a more robust lamp against mechanical impact. One disadvantage of this known lamp is that the manufacturing process of said known lamp is relatively complicated as furnishing the viscous cement requires cumbersome control of the amount and flow of the cement which involves an enhanced risk on spilling. Another disadvantage of the known lamp is that for mutual fixation of the base and the sleeve, the cement needs to be cured with requires relatively long curing times. Yet, another disadvantage is that high demands are posed on the properties of the cement as it has to adhere to both the sleeve and to the base which adherence has to be maintained during lifetime of the lamp, which means that, because of heating up to over 350° C. and cooling down to room temperature (20° C.) due to duty cycles of the lamp, the thermal expansion of the cement has to match with both the sleeve and the base.

### SUMMARY OF THE INVENTION

1. It is an object of the invention to provide an electric lamp of the type as described in the opening paragraph in which at least one of the abovementioned disadvantages is counteracted. Thereto the lamp of the type as described in the opening paragraph is characterized in that a cylindrical connection part having only at a first opening an at least one rigid, radially inwardly extending portion, connects the base to the sleeve, the sleeve extending through said first opening of the connection part and engaging with an at least one radially, outwardly bulging portion the at least one radially, inwardly extending portion of the connection part, the base extending through a second opening of the connection part opposite to the first opening and being fixed to the connection part. Due to the outwardly bulging portion of the sleeve and or the rigid, inwardly extending portion, the sleeve and the connection part have mutual form factors and local diameters that hinder the sleeve to be completely passed through the first opening of the connection part. Its passage will be blocked by its outwardly bulging part and/or by the rigid, inwardly extending portion, and the connection part and the sleeve will mutually hook/abut each other. The rigid inwardly extending portion may have some limited deformability, but not enough deformability to let pass the outwardly bulging part of the sleeve. Thus an easy fixation of the sleeve onto the connection part is attained, without the use of any cement, thus providing a reliable connection between sleeve and base and avoiding long curing times of the cement during the manufacturing process of the lamp. The connection part subsequently is fixed to the base, i.e. slid over it and fixed to the base, for example laser welded, peened, deformed, screwed or via resilient clips.

2/3/6. To attain a mutual hook or abutment of the sleeve and the connection part without the necessity of mutual alignment, an embodiment of the electric lamp is characterized in that said at least one inwardly extending portion and/or said at least one outwardly bulging portion is evenly distributed over a circumference of the connection part and extends over at least 50% of said circumference. Preferably said at least one outwardly bulging portion is essentially fully circumferential. In that case a fully circumferential support of base and sleeve is attained, resulting in an improved mutual fixed position of sleeve and connection part.

4/7. An embodiment of the electric lamp is characterized in that said at least one outwardly bulging portion is a circumferential, conical or stepped flare. A self centering effect is obtained with a sleeve having a conical flare that engages with a conical flange of the connection part. It is therefore preferred that the connection part has a matching conically shaped inwardly extending portion. In the case of stepped flare and stepped flange an improved thermal shock resistance of the electric lamp is obtained because of the possibility of sliding in radial direction of the sleeve outwardly bulging portion along the inwardly extending portion of the connection part upon sudden shrinkage or expansion of either one of the connection part and the outer envelope.

5/8/9/10. An embodiment of the electric lamp is characterized in that said at least one outwardly bulging portion is provided with at least one local indent, for example a V-shaped groove or a U-shaped slot. In assembled configuration, such an indent is provided to accommodate a snugly fitting notch of the base at a base end facing towards the sleeve, thus attaining an interlocking configuration against undesired, mutual rotational movement of sleeve and base. Optionally more than one indent and notch are provided on the respective parts in a mutual matching configuration.

11/12. Another embodiment of the electric lamp is characterized in that the connection part comprises at least one resilient sleeve snap fastener. Once the sleeve has passed practically wholly through the connection part and is about to abut with its outwardly bulging portion against the inwardly extending portion of the connection part, the outwardly bulging portion at the open end of the sleeve passes beyond the resilient sleeve snap fastener. Subsequently said resilient sleeve snap fastener moves somewhat radially inwards to hook behind said open end of the sleeve. An additional advantage of the resilient sleeve snap fasteners is the mutually self centering or aligning effect of sleeve and connection part. Thus, a simple fixation of the sleeve in the connection part and blocking it from moving back into the connection part is obtained. Similarly the fixation of the base to the connection part can be obtained with an embodiment of the electric lamp which is characterized in that the connection part comprises at least one resilient base snap fastener. When the connection part comprises both the sleeve snap fastener and the base snap fastener a simple, reliable connection of the sleeve to the base via the connection part is obtained.

13/14. It is not required that the sleeve/base snap fasteners hook behind an end of either the sleeve or the base, each of the sleeve or base could be provided with at least one recess for accommodating at least one resilient snap fastener thus enabling the electric lamp to be relatively compact. Preferably, the at least one recess is provided in an outer wall of the base, once the snap fastener is accommodated in the recess of the base it is flush with the remainder circumferential outer surface of the connection part.

15. The invention further relates to a method of assembling an electric lamp according to the invention, comprising the steps of mounting a gastight lamp vessel on a base along a length axis, sliding a connection part over a sleeve and engaging an at least one outwardly bulging portion of the sleeve in/on an at least one inwardly extending portion of the connection part, and sliding the connection part with seated sleeve over the lamp vessel mounted on the base until the base abuts the outer envelope, and subsequently mechanically fixing the connection part to the base. Thus, a relatively simple assembling process of an electric lamp is obtained in which the use of cumbersome and time consuming process steps with cement is avoided.

The electric lamp can be of the type of a high pressure gas discharge lamp, for example a CDM lamp with a lamp vessel made of ceramic material as TGA or garnet, or metal halide gas discharge lamp with a lamp vessel made of quartz glass, comprising a pair of oppositely arranged electrodes, between which a discharge is present as a light emitting element during operation. Alternatively the electric lamp can be a halogen incandescent lamp comprising a filament as a light source.

### BRIEF DESCRIPTION OF THE DRAWINGS

The invention will now be further elucidated by means of the schematic drawing in which:

FIG. 1 shows a cross section of a first embodiment of an assembled electric lamp according to the invention;

FIG. 2a-c shows respectively a perspective view of an embodiment of a sleeve and an embodiment of a base and a cross section of an embodiment of a connection part of the lamp of FIG. 1;

FIG. 3a-b shows respectively a perspective view of second embodiments of a connection part and a sleeve;

FIG. 4 shows a perspective view of a second embodiment of and assembled electric lamp according to the invention;

FIG. 5a-d show respectively a cross section and a perspective view of a third embodiment of a sleeve and of a third embodiment of a connection part.

In the figures as much as possible will be adhered to the use of the same reference numbers for the corresponding parts.

DETAILED DESCRIPTION OF THE DRAWINGS

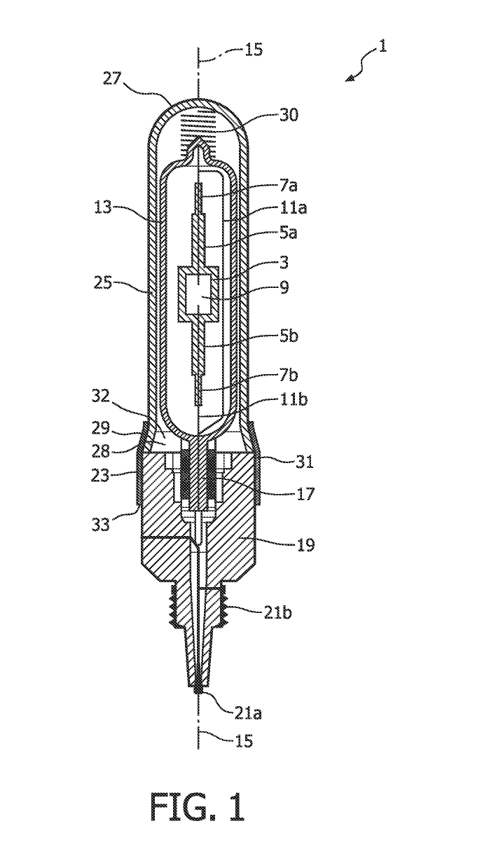

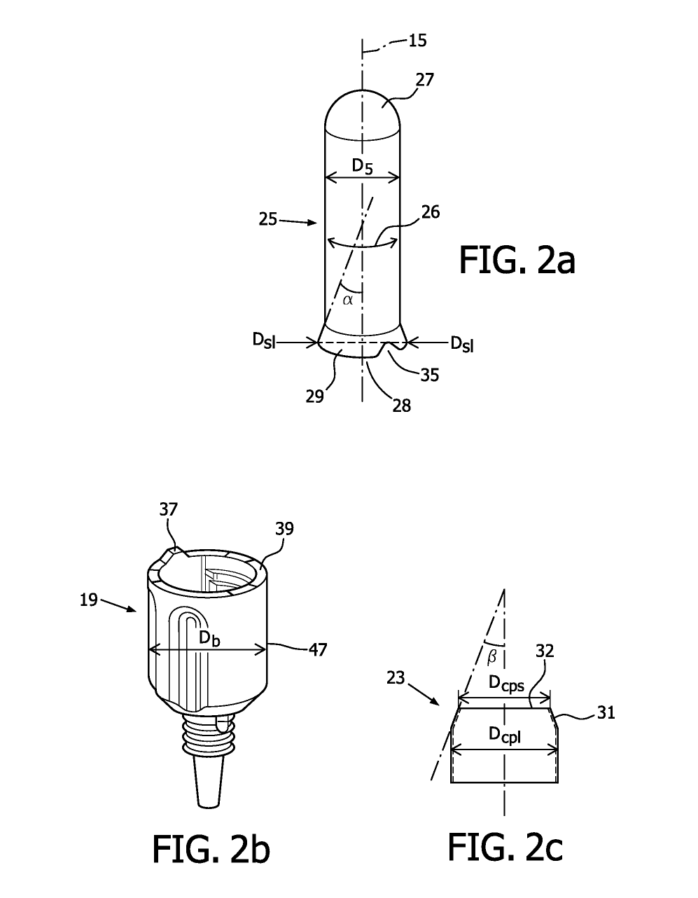

FIG. 1 shows an electric lamp 1 according to the invention comprising a gastight lamp vessel 3, in the figure made of ceramic, for example gastightly sintered, translucent Al₂O₃ but which could alternatively be made of fused silica. The lamp vessel has two oppositely arranged seals 5a,5b through which respective electric feedthroughs 7a,7b extend from the inside 9 of the lamp vessel to outside the lamp vessel where they are connected to respective current conductors 11a,11b. The lamp vessel is mounted by its current conductors inside an outer bulb 13, for example made of hard glass, and along a length axis 15. The outer bulb is mounted with a bulb seal 17 in a base 19 where the current conductors are connected to a central electrical base contact 21a and a screw-shaped base contact 21b. The base, for example made of sintered Al₂O₃, is connected via a practically tubular shaped connection part 23, for example made of NiCr stainless steel, to a sleeve 25, for example made of quartz glass or hard glass, for example aluminosilicate or borosilicate glass, which, in assembled position, is fitted over the outer envelope of the lamp. The sleeve has a tubular shape with a dome end 27 and opposite thereto an open end 28, shaped as an essentially circumferential flare, except for a local indent (see FIG. 2a), as an outwardly bulging portion 29. During assembling of the lamp the sleeve is passed through the connection part until it abuts with its flare 29 against a conically tapering flange 31 as a first, inwardly extending portion at a first opening 32 of the connection part. Subsequently the base with mounted lamp vessel and outer bulb is partly inserted inside the sleeve through the connection part and base and connection part at a second opening 33 are welded together to mutually fixate the sleeve, base and connection part. As shown in FIG. 1 in assembled position the base practically touches/abuts the sleeve and comprises the electric lamp a spring 30 provided between the outer bulb 13 and the dome end 27 to further improve mutual fixation of the sleeve and the outer bulb.

FIG. 2a-c shows, except for the lamp vessel and outer envelope, the basic parts of the lamp of FIG. 1, i.e. the sleeve 25, the base 19 and the connection part 23. As clearly shown in FIG. 2a, the sleeve is essentially of a tubular shape with a domed end 27 and has over its circumference 26 a fully circumferential, conical flare 29 provided with one local indent 35. The angle of the conical flare with respect to the length axis 15 of the sleeve normally is in a range of 5° to 20°, for example about 15°. In an assembled configuration said indent is to accommodate a notch 37 which is provided on the base at base end 39 which faces towards the open end 28 of the sleeve, thus counteracting mutual rotation of sleeve and base. FIG. 2c shows as cross section of the substantially circular c connection part via which both sleeve and base are mutually connected. The connection part has at its first opening 32 a tapering, frustrated conical flange 31 as an inwardly extending portion. The angle B the conical part makes with the length axis 15 is generally in a range of 5° to 25°, for example about 20°, preferably a little less acute than the angle as used in the sleeve thus counteracting that a slit remains between sleeve and connection part at the first opening 32 of the connection part, to be determined in dependence of the mutual friction between the material of the sleeve and the connection part. Also shown in FIG. 2a-c is that the tubular, straight cylindrical sleeve has an outer diameter Dₛ which is just smaller than a smallest inner diameter D_{cps} of the connection part at the first opening 32 of the connection part. Furthermore, the sleeve has a largest diameter Dₛₗ at its open end 28 which is larger than D_{cps} but just somewhat smaller than a largest diameter D_{cpl} of the connection part enabling the sleeve to pass for its major part through the connection part until further passage is blocked because Dₛₗ>D_{cps}. The substantially cylindrical part 47 of the base snugly fits in the connection part as the cylindrical part of the base has a diameter D_{b} which just is somewhat smaller than the largest diameter D_{cpl} of the connection part.

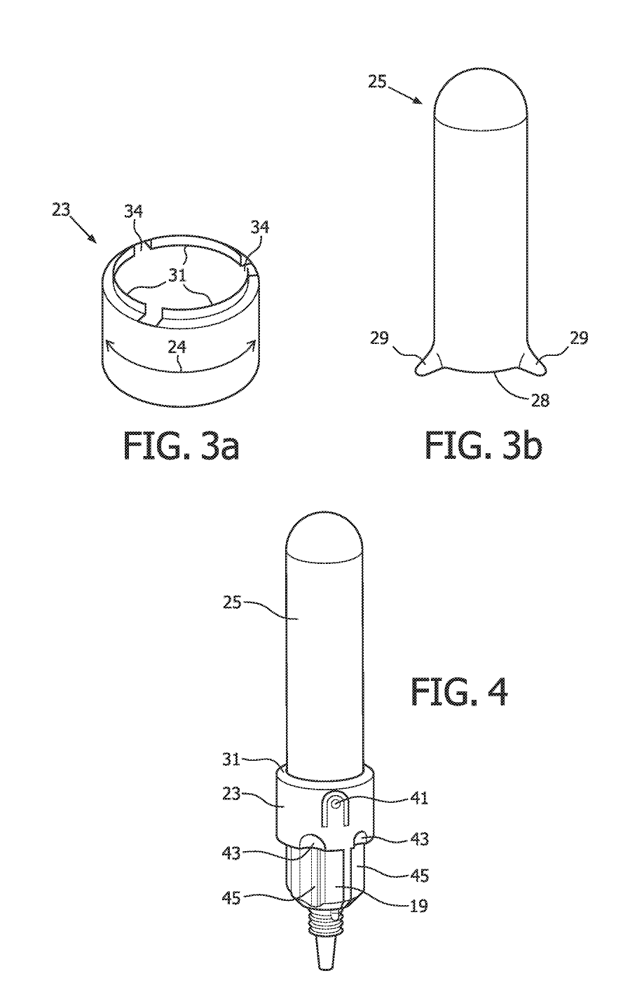

FIG. 3a-b shows respectively a perspective view of second, alternative embodiments of a connection part 23 and a sleeve 25. In the connection part three inwardly extending portions 31 are evenly distributed over a circumference 24 of the connection part separated by gaps 34 and extend over at least 50% of said circumference. In the sleeve three (only two are shown), radially outwardly bulging portions 29 are provided, in the figure embodied as tongues, said portions are evenly distributed over the circumference of the open end 28 of the sleeve. Said tongues have a dimension in tangential direction that is somewhat larger than a tangential dimension of the gaps, thus blocking passage of said tongues through said gaps, yet said tongues can accommodate well in the gaps to counteract mutual rotation of sleeve and connection part. With the embodiment of the connection part shown in FIG. 3a a tight connection between connection part and sleeve is obtained at both elevated temperatures during operation of the electric lamp and at room temperature, as the inwardly extending portion of the connection part is in three resilient parts that can cope with the radial expansion and shrinkage of the sleeve.

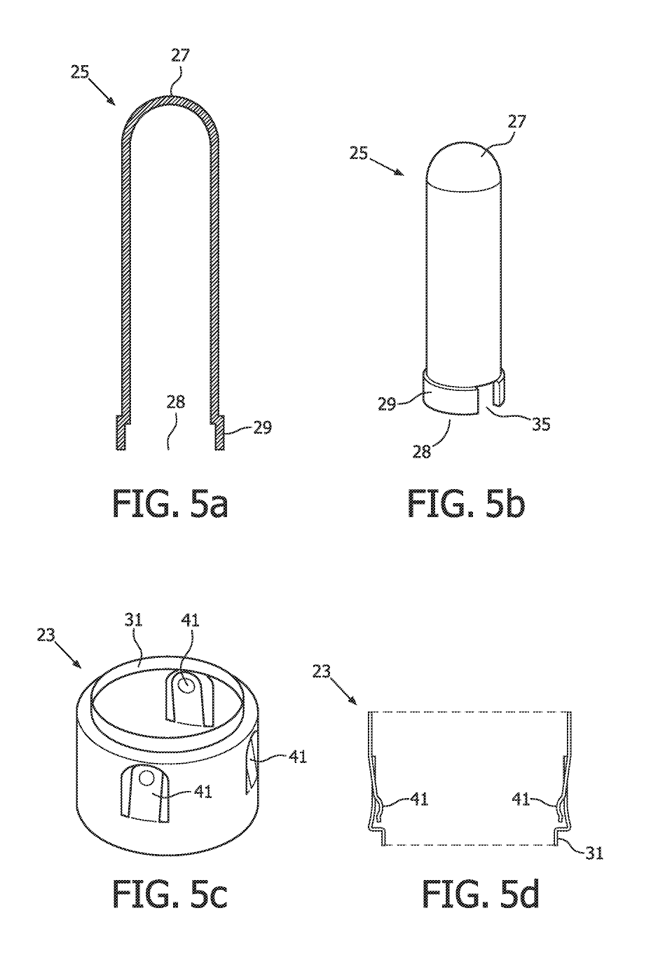

FIG. 4 shows a perspective view of a second embodiment of and assembled electric lamp according to the invention. The connection part 23, with its fully circumferential inwardly extending flange 31 snugly fits around the sleeve 25, has additional resilient sleeve snap fasteners, i.e. in the figure resilient fingers 41 (see also FIG. 5c-d) that are snapped behind the open end of the sleeve thus fixate the sleeve to the connection part. Furthermore, the connection part has welded spots 43 via which it is welded to recesses 45 in the base 19, alternatively these welded spots could be resilient base snap fasteners, for example being shaped as resilient clips, that are accommodated in local recesses in the base. Thus the base and the connection part are mutually fixated.

FIG. 5a-d shows respectively a cross section and a perspective view of a third embodiment of a sleeve and of a third embodiment of a connection part. The sleeve 25 as shown in FIG. 5a in cross section is a tube with a domed end 27 and opposite thereto an open end 28 which is embodied as a radially outwardly extending stepped flare 29. As shown in FIG. 5b said flare is provided with a local indent 35, in the figure a U-shaped gap. The connection part 23 as shown in FIGS. 5c-d is provided with a fully circumferential inwardly extending flange 31. Furthermore said connection part is provided with four resilient clips or fingers 41 evenly distributed over the circumference of the cylindrically shaped connection part.

1. An electric lamp comprising a gastight lamp vessel mounted on a base,
the lamp vessel being surrounded by a sleeve having a length axis and an open end, the base being connected at the open end of the sleeve;
wherein a cylindrical connection part having at a first opening an at least one rigid, radially inwardly extending portion, connects the base to the sleeve, the sleeve extending through said first opening of the connection part and engaging with an at least one radially, outwardly bulging portion the at least one radially, inwardly extending portion of the connection part;
wherein the cylindrical connection part has only at the first opening the t least one rigid, radially inwardly extending portion, and that the base extending through a second opening of the connection part opposite to the first opening is fixed to the connection part by means of welding, peening, deforming, screwing or resilient clips.

2. An electric lamp as claimed in claim 1, wherein said at least one inwardly extending portion and/or said at least one outwardly bulging portion is evenly distributed over a circumference of the connection part and extends over at least 50% of said circumference.

3. An electric lamp as claimed in claim 2, wherein said at least one outwardly bulging portion is essentially fully circumferential.

4. An electric lamp as claimed in claim 3, wherein said at least one outwardly bulging portion is a circumferential conical or stepped flare.

5. An electric lamp as claimed in claim 3, wherein said at least one outwardly bulging portion is provided with at least one local indent.

6. An electric lamp as claimed in claim 2, wherein said at least one inwardly extending portion is essentially fully circumferential.

7. An electric lamp as claimed in claim 6, wherein said at least one inwardly extending portion is a circumferential conical or stepped flange.

8. An electric lamp as claimed in claim 7, wherein said at least one inwardly extending portion has a matching shape to outwardly bulging portion of the sleeve.

9. An electric lamp as claimed in claim 1, wherein said the base is provided with at least one local notch at a base end facing towards the sleeve.

10. An electric lamp as claimed in any claim 9, wherein said at least one inwardly extending portion snugly fits into the local indent of the sleeve.

11. An electric lamp as claimed in claim 1, wherein the connection part comprises at least one resilient sleeve snap fastener.

12. An electric lamp as claimed in claim 1, wherein the connection part comprises at least one resilient base snap fastener.

13. An electric lamp as claimed in claim 12, wherein the base comprises at least one recess for accommodating at least one resilient base snap fastener.

14. An electric lamp as claimed in claim 13, wherein the at least one recess is provided in an outer wall of the base.

15. Method of assembling an electric lamp, comprising the steps of:
mounting a gastight lamp vessel on a base along a length axis;
sliding a connection part over a sleeve and engaging an at least one outwardly bulging portion of the sleeve in/on an at least one inwardly extending portion only at a first opening of the connection part;
sliding the connection part with seated sleeve over the lamp vessel mounted on the base until the base abuts the outer envelope, and subsequently mechanically fixing the connection part to the base by means of welding, peening, deforming, screwing or resilient clips.
